(19) United States
(12) Patent Application Publication
(10) Pub. No.: US 2018/0129964 A1
(43) Pub. Date: May 10, 2018

(54) METHOD, APPARATUS, AND COMPUTER STORAGE MEDIUM FOR PRE-SELECTING AND SORTING PUSH INFORMATION

(71) Applicant: TENCENT TECHNOLOGY (SHENZHEN) COMPANY LIMITED, Shenzhen (CN)

(72) Inventors: Lei JIANG, Shenzhen (CN); Ge CHEN, Shenzhen (CN); Lieqiong JIANG, Shenzhen (CN); Lei LIU, Shenzhen (CN); Dongbo HUANG, Shenzhen (CN); Wenjie LI, Shenzhen (CN); Hao HUANG, Shenzhen (CN); Junqing GU, Shenzhen (CN); Wei HUANG, Shenzhen (CN); Zhi JIANG, Shenzhen (CN); Hong ZHANG, Shenzhen (CN); Lan XU, Shenzhen (CN); Siyu ZHU, Shenzhen (CN); Wei JIN, Shenzhen (CN)

(21) Appl. No.: 15/863,584

(22) Filed: Jan. 5, 2018

Related U.S. Application Data
(63) Continuation of application No. PCT/CN2016/112496, filed on Dec. 27, 2016.

(30) Foreign Application Priority Data
Jan. 4, 2016 (CN) 201610006885.5

(51) Int. Cl. G06N 7/00; G06Q 30/02; G06N 5/02

(52) U.S. Cl. CPC G06N 7/005; G06N 5/02; G06Q 30/0254

(57) ABSTRACT

Embodiments of the present invention disclose a push information pre-selecting method and apparatus. The method includes: based on historical push data of push information including a plurality of push information items, determining a feature for calculating a predicted value, and a weight corresponding to the feature; calculating a standard deviation of the feature; determining a fluctuation probability of the standard deviation; calculating the predicted value based on the weight, the standard deviation, and the fluctuation probability, the standard deviation and the fluctuation probability being used for calculating a fluctuation value for correcting the weight; based on the predicted value, selecting push information items satisfying a preset condition; and pushing the selected push information items to a target user.

### CROSS-REFERENCES TO RELATED APPLICATIONS

This application is a continuation application of PCT Patent Application NO. PCT/CN2016/112496, filed on Dec. 27, 2016, which claims priority to Chinese Patent Application NO. 2016100068855, entitled “METHOD, APPARATUS, AND COMPUTER STORAGE MEDIUM FOR PRE-SELECTING AND SORTING PUSH INFORMATION” filed on Jan. 4, 2016, all of which are incorporated by reference in its entirety.

### FIELD OF THE TECHNOLOGY

The present disclosure relates to the field of information processing and, in particular, to a method and an apparatus for pre-selecting and sorting push information and a computer storage medium.

### BACKGROUND OF THE DISCLOSURE

With the development of the information technology, in the field of information push, how to determine a target user to push information and how to improve the efficiency of information push has long been the problem to be resolved. The information push includes advertisement push, and a video, an audio, and picture and text information recommended to a user, and the like. To send to the user push information that the user is interested in and to improve transmission of push information and effective resource utilization rate, popularities of the various push information items are sorted and predicted. During prediction, pre-selection-and-sorting and selection-and-sorting of the predicted values is included. During pre-selection-and-sorting, based on current data of the push information, a small amount of push information with relatively high popularities is selected from hundreds of thousands of push information items and, then, during the selection-and-sorting, the popularities and predicted probabilities to be viewed or clicked of the pre-selected push information items are further accurately sorted.

However, with the existing technology, often some push information is very popular with users, but issues such as short push time of the push information can cause such push information being filtered out during the pre-selection, lowering the accuracy of the processing results. The disclosed methods and systems are directed to solve one or more problems set forth above and other problems.

### SUMMARY

In view of the above, embodiments of the present invention provide a method and an apparatus for pre-selecting and sorting push information, and a computer storage medium, to at least partially resolve the problem of low accuracy of the pre-selection result. Technical solutions of the embodiments are implemented in the followings.

One aspect of the embodiments of the present invention provides a method for pre-selecting push information, the method including: based on historical push data of push information including a plurality of push information items, determining, by a computing terminal including at least one processor, a feature for calculating a predicted value, and a weight corresponding to the feature; calculating, by a computing terminal, a standard deviation of the feature; determining, by a computing terminal, a fluctuation probability of the standard deviation; calculating, by a computing terminal, the predicted value based on the weight, the standard deviation, and the fluctuation probability, the standard deviation and the fluctuation probability being used for calculating a fluctuation value for correcting the weight; based on the predicted value, selecting, by a computing terminal, push information items satisfying a preset condition; and pushing, by a computing terminal, the selected push information items to a target user.

Another aspect of the embodiments of the present invention provides an apparatus for pre-selecting push information. The apparatus includes a memory storing instructions; and a processor coupled to the memory. when executing the instructions, the processor is configured for: based on historical push data of push information including a plurality of push information items, determining a feature for calculating a predicted value, and a weight corresponding to the feature; calculating a standard deviation of the feature; determining a fluctuation probability of the standard deviation; calculating the predicted value based on the weight, the standard deviation, and the fluctuation probability, the standard deviation and the fluctuation probability being used for calculating a fluctuation value for correcting the weight; based on the predicted value, selecting push information items satisfying a preset condition; and pushing the selected push information items to a target user.

Another aspect of the embodiments of the present invention provides a non-transitory computer-readable storage medium containing computer-executable instructions for, when executed by one or more processors, performing a push information pre-selecting method. The method includes: based on historical push data of push information including a plurality of push information items, determining a feature for calculating a predicted value, and a weight corresponding to the feature; calculating a standard deviation of the feature; determining a fluctuation probability of the standard deviation; calculating the predicted value based on the weight, the standard deviation, and the fluctuation probability, the standard deviation and the fluctuation probability being used for calculating a fluctuation value for correcting the weight; based on the predicted value, selecting push information items satisfying a preset condition; and pushing the selected push information items to a target user.

Other aspects of the present disclosure can be understood by those skilled in the art in light of the description, the claims, and the drawings of the present disclosure.

### BRIEF DESCRIPTION OF THE DRAWINGS

FIG. 1 is a schematic flowchart of a push information pre-selecting method according to embodiments of the present invention;

FIG. 2 is a schematic flowchart of another push information pre-selecting method according to embodiments of the present invention;

FIG. 3 is a schematic structural diagram of a push information pre-selecting apparatus according to embodiments of the present invention;

FIG. 4 is a schematic structural diagram of another push information pre-selecting apparatus according to embodiments of the present invention; and

FIG. 5 is a schematic flowchart of a process calculating a predicted value according to embodiments of the present invention.

### DESCRIPTION OF EMBODIMENTS

The technical solutions of the present invention are further stated in detail below with reference to the accompanying drawings and specific embodiments of the specification. It should be understood that the embodiments described below are only used for describing and explaining the present disclosure and not for limiting the present disclosure.

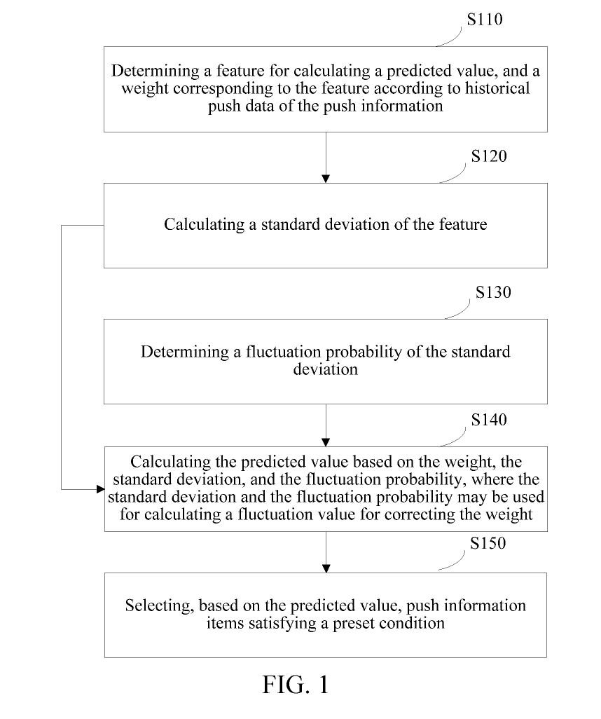

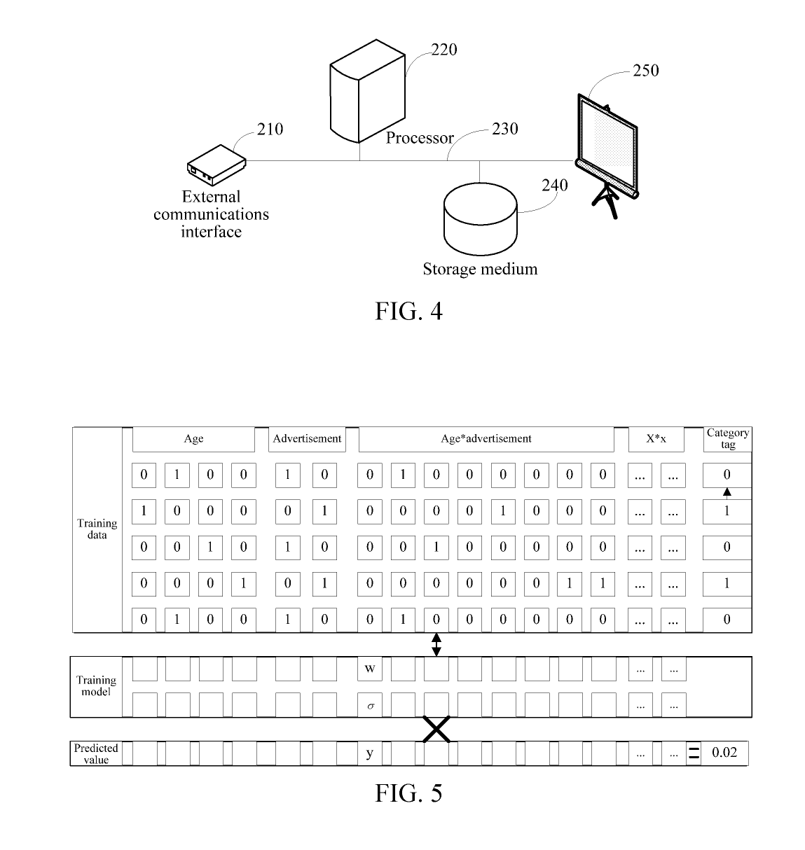

As shown in FIG. 1, the present disclosure provides a push information pre-selecting method. The disclosed push information method can be implemented by a computing terminal (e.g., an apparatus as shown in FIG. 4). The computing terminal may be a computer, a server, a tablet, a smart phone, or a combination thereof. The method includes the followings.

Step S110: Based on historical push data of the push information, determining a feature for calculating a predicted value, and a weight corresponding to the feature.

Step S120: Calculating a standard deviation of the feature.

Step S130: Determining a fluctuation probability of the standard deviation.

Step S140: Calculating the predicted value based on the weight, the standard deviation, and the fluctuation probability, where the standard deviation and the fluctuation probability are used for calculating a fluctuation value to correct the weight.

Step S150: Based on the predicted value, selecting push information items satisfying a preset condition. Further, the selected push information items may be pushed to a target user.

The push information may be referred as a collection of or a collective term for one or more push information items, which may be individually processed and/or pushed. The push information may include any information that can be pushed to one or more users. For example, the push information may include information such as advertisement. The advertisement may include various types of advertisement, such as social advertisement. The push information pre-selecting method may be applied on various push platforms of push information, or may be used in various selection devices for determining effective push information to be used.

Further, in step S110, when the push information is advertisement, the historical push data of the push information may include historical advertisement data. The historical advertisement data may include various data formed in the push process based on push information, such as seed users that click, view, or execute conversion behaviors expected by an advertisement, action effective period, click rate, conversion rate, advertisement placement position, and an advertisement placement time, etc. The conversion behaviors may include operations that push information desires a user to perform, such as downloading an application (APP) and purchasing services and commodities promoted in the corresponding push information.

In one embodiment, the standard deviation calculated in step S120 is a standard deviation of a certain feature. The standard deviation may be a standard deviation of an operation result in the historical push data when the feature is a specified value. The operation result may be used for representing a value indicating whether a user, whose feature is the specified value, performs an operation expected by the push data.

For example, using advertisement A as an example, a corresponding feature is the age of the users. If four bits respectively represent four different age groups, assuming that a user C is in a first age group, a first bit corresponding to the first age group is 1, and other bits are 0. In this case, the value of the feature of age is 1000.

When a standard deviation is calculated, if data rows of historical push data whose age feature is 1000 are used, these data rows include a column of operation results whether the user clicks the advertisement A. Assuming that “1” represents clicking the advertisement, and “0” represents not clicking the advertisement in the column of operation results. For example, values of age features of 50 data rows among data rows of the historical push data are 1000, and 50 columns of result columns are extracted as sample data to calculate the standard deviation. The calculated standard deviation is a standard deviation of the age feature in the first age group.

When the predicted value is calculated, a set of users that receive the push information are determined, and age features of these users are extracted. Based on the above calculated standard deviation, a probability value of clicking of the advertisement pushed among the users in the first age group can be calculated. For another example, the value of the feature is “gender being female”, and a standard deviation of the feature “gender being female” is a standard deviation of executing, by a female, a conversion operation expected by the push information in the historical push data. For example, the standard deviation is a standard deviation of clicking the advertisement by a female.

The fluctuation probability of the standard deviation is determined in step S130. In one embodiment, the fluctuation probability may be determined by using a preset algorithm, for example, the fluctuation probability is determined by using a random algorithm. The random algorithm may include a Gaussian random algorithm.

The predicted value is calculated based on the weight, the standard deviation, and the fluctuation probability in step S140. The weight may be a weight of each feature that correspondingly calculates the predicted value.

In one embodiment, features used in calculation of the predicted value may include features of the push information and user features. The push information may include a push position and a push identifier. The push identifier may be a sequence number of the push information. The push position may include a release position in which the push information is released. The release position may include an information release position on a social application, for example, WeChat moments, a home page of an application login interface, and a page header part of an application page. Certainly, the release position may also include a home page of a browser, a side advertisement position of a browser, a floating window, and the like. The user features may include features of users that read the push information, click the push information, or execute other conversion behaviors expected by the push information. These user features may include various features that can represent user characteristics, such as age, gender, profession, behavior preference, hobbies, and consumption levels, etc.

In one embodiment, the predicted value may be used for representing continuing releasing the push information, and a probability of executing, by the user, the conversion behavior expected by the push information. For example, the advertisement A has been released for a certain period of time, and the feature standard deviation can be calculated according to historical advertisement data formed by releasing of the advertisement A. The fluctuation probability is determined in step S130 and, in step S140, the weight is corrected by using the standard deviation and the fluctuation probability to obtain a corrected weight. Then, a probability for the advertisement A to be subsequently clicked is predicted by using the corrected weight.

The predicted value may be specifically calculated by using the following formula in step S140:

$$y = \frac{1}{1 + {e}^{- \sum ( {w}_{i} + \sqrt{{σ}_{i}^{2} * p} ) {x}_{i}}}$$

In this formula, y is the predicted value, xᵢ is a value of a feature i, wᵢ is a weight of the feature i, and σᵢ is a standard deviation of the feature. In one embodiment, the predicted value is calculated by using a logistic regression algorithm. In specific implementation, the predicted value may also be calculated by using a Bayesian algorithm. Further, wᵢ+\sqrt{σᵢ²*p} is a corrected weight obtained by calculation based on the fluctuation probability and the standard deviation. In the Bayesian algorithm, the original weight may be replaced with the corrected weight, so that the predicted value is also obtained by calculation. It should be noted that, in one embodiment, there are I features in total, and a value of i is from 1 to I, where I is an integer not less than 1. It should be noted that −Σ(wᵢ+\sqrt{σᵢ²*p})xᵢ is an exponent of e, and e is a natural constant.

In specific implementation, predicted values may be sorted according to the predicted values of various push information items, and the push information items ranked ahead are then selected as the result of the pre-selecting of the push information; or push information items whose predicted values are greater than a pre-selection threshold are used as the result of the pre-selecting of the push information. Thus, after step S140, in one embodiment, push information items satisfying the preset condition may also be selected based on the predicted values. The selected push information items may be used as push information for effect push. The effect push may be push operations paid based on the push effect.

In one embodiment, the standard deviation and the fluctuation probability are introduced to correct the weight. In this way, push information items currently having a relatively short push time or a relatively small push amount but achieving the expected push effect can participates in competition, reducing the occurrence of situations in which the push information with a relatively small push amount is missed due to the relatively small push amount during the pre-selection. Thus, the amount of push information with desired push effects selected during pre-selection can be increased.

For example, advertisements are identified by orders. When an advertisement has some orders, the advertisement can be placed to an advertisement platform. Due to a short placement time or a small placement amount, the advertisement has relatively few historical advertisement data. If the advertisements are pre-selected by using the existing technology, advertisements with small placement amount or short placement time may be easily filtered and, consequently, the pre-selected advertisements are not one or more advertisements with best placement effects, causing low the pre-selection accuracy. However, according to the disclosed information processing method, in one embodiment, by introducing the fluctuation probability and the standard deviation, reducing the occurrence of situations where push information with good push effects is missed due to the large fluctuation of data caused by small historical push data, and thereby improving the pre-selection accuracy.

In some embodiments, the method further includes: determining a fluctuation coefficient, where the fluctuation coefficient is used for limiting a value range of the fluctuation value.

Step S140 may include: calculating the predicted value based on the weight, the standard deviation, the fluctuation probability, and the fluctuation coefficient.

That is, in one embodiment, the method may also use the fluctuation coefficient, and the fluctuation coefficient is used for limiting a value range of the fluctuation value. When a standard deviation of a feature is excessively large, the value of the fluctuation value may be excessively large. The fluctuation coefficient is introduced for performing a multiplication operation with a result obtained based on the fluctuation probability and the standard deviation, to obtain the fluctuation value.

In one embodiment, the fluctuation coefficient may be an integer greater than 0 and not greater than 1. If the value of the fluctuation coefficient is 0, in this example, the fluctuation value may be 0. In this case, the weight is not corrected, so that the phenomenon of large fluctuation of the standard deviation caused by a small data amount of the historical push data can be avoided. The fluctuation coefficient may be a preset parameter, a value that can be known in advance when the push information pre-selecting method calculates the fluctuation value. Specifically, the fluctuation coefficient may be an empirical value obtained according to historical operation records or an experimental value obtained from experimental data by means of one or more experiments. Accordingly, the fluctuation coefficient may be introduced to adjust the fluctuation value, to avoid that the fluctuation value is excessively large or excessively small, and to avoid the situation where the calculation result is not sufficiently accurate due to excessively large fluctuation of the feature value, further improving the pre-selection accuracy.

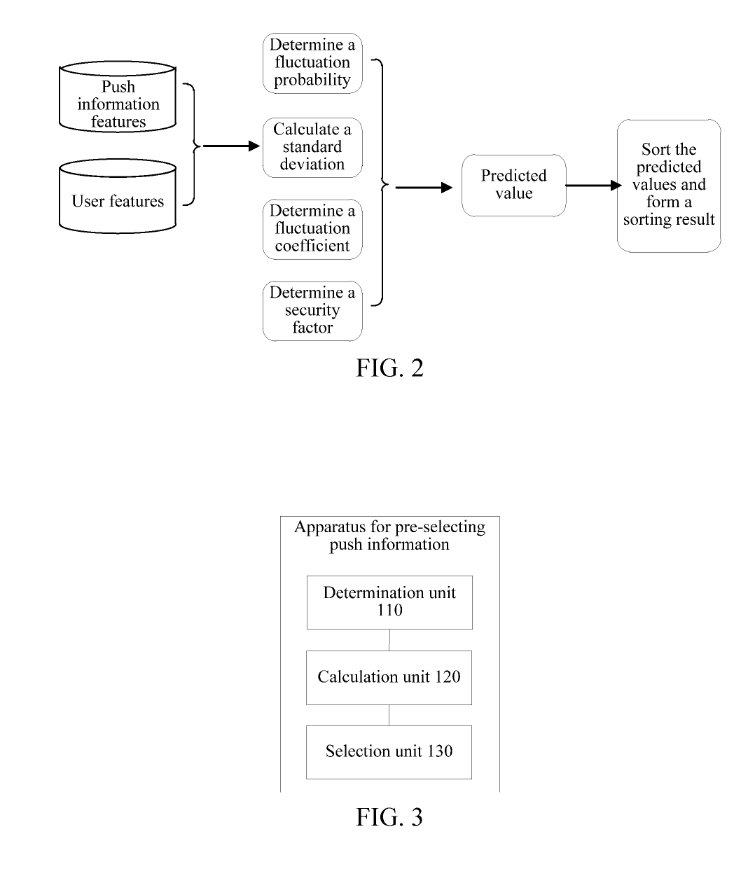

FIG. 2 illustrates a schematic flowchart of another push information pre-selecting method according to the disclosed embodiments. The method specifically includes: extracting push information features and user features; calculating standard deviations, where the calculating standard deviations includes calculating various standard deviations of features for calculating predicted values; before or after calculating the standard deviations, determining a fluctuation coefficient; determining a safety factor; and determining a fluctuation probability; calculating the predicted values based on the fluctuation probability, the standard deviation, the fluctuation coefficient, and the safety factor; and finally sorting the predicted values to form a sorting result; and selecting, based on the sorting result, push information whose predicted value is ranked ahead as a pushing result.

In some other embodiments, the method further includes: determining a fluctuation coefficient, where the fluctuation coefficient is used for limiting a value range of the fluctuation value.

Step S150 may include: calculating the predicted value based on the weight, the standard deviation, the fluctuation probability, and the fluctuation coefficient. The method may further include: determining a safety factor, where the safety factor is used for preventing abnormal solution of the fluctuation value caused when the standard deviation is a particular value or the standard deviation is not obtained.

Step S140 may include: calculating the predicted value based on the weight, the standard deviation, the fluctuation probability, and the safety factor.

The safety factor is introduced to prevent abnormal or extreme standard deviations. If the standard deviation has an abnormal or extreme situation, certain ways may be used to determine that the standard deviation is abnormal. For example, when the standard deviation is of a particular value, specifically, when the standard deviation is 0, it can be determined that the standard deviation is abnormal or extreme. In one embodiment, when no standard deviation is obtained, it can also be determined that the standard deviation is abnormal, as usually, if the standard deviation is not obtained, the standard deviation is defaulted as 0. If the standard deviation is 0, it may lead to that the fluctuation value is 0 and, thus, a safety factor is introduced. The safety factor may be an extremely small positive number. In one embodiment, the safety factor is a constant less than a predetermined value, for example, a constant not greater than one thousandth, such as one ten-thousandth.

When the standard deviation is normal, an extremely small value has extremely small interference to calculation of the fluctuation value. When the standard deviation is abnormal, the safety factor is an extremely small positive number, so that the fluctuation value is not 0, but the fluctuation value is also extremely small. In this way, because of introduction of the safety factor, an electronic device can avoid an abnormal predicted value caused by the abnormal fluctuation value.

As further improvement, an example based on the fluctuation probability, the standard deviation, the safety factor, and the fluctuation coefficient is particularly provided below. Step S150 may include: calculating the predicted value y by using the following formula:

$$y = \frac{1}{1 + {e}^{- \sum ( {w}_{i} + α \sqrt{\frac{1}{β + \frac{1}{{σ}_{i}^{2}}} * p} ) {x}_{i}}}$$

where xᵢ is a value of a feature i, wᵢ is a weight of the feature i, α is the fluctuation coefficient, β is the safety factor, and σᵢ is a standard deviation of the feature.

Obviously, σᵢ cannot be 0. If σᵢ is 0,

$$\frac{1}{{σ}_{i}^{2}}$$

is abnormal, causing a fluctuation value abnormity. In this way, an abnormity of predicted value calculation is caused. Certainly, in specific implementation, a situation in which the standard deviation of the feature value of the push information is 0 hardly occurs.

It should be noted that, in one embodiment, there are I features in total, and a value of i is from 1 to I, where I is an integer not less than 1.

According to the above formula, the predicted value for pre-selecting the push information can be conveniently and accurately calculated, and a probability of occurrence of an abnormity is relatively small in a calculation process, and a value range of the fluctuation value is within a controllable range, thereby greatly improving the pre-selection accuracy of the push information.

As shown in FIG. 1, an embodiment of the present disclosure provides another push information pre-selecting method, the method includes the followings.

Step S110: Determining a feature for calculating a predicted value, and a weight corresponding to the feature according to historical push data of the push information.

Step S120: Calculating a standard deviation of the feature.

Step S130: Determining a fluctuation probability of the standard deviation.

Step S140: Calculating the predicted value based on the weight, the standard deviation, and the fluctuation probability, where the standard deviation and the fluctuation probability may be used for calculating a fluctuation value for correcting the weight.

Step S150: Selecting, based on the predicted value, push information items satisfying a preset condition.

The push information pre-selecting method of this embodiment is similar to those technical solutions of the previously-described embodiments. For example, step S140 may use the formula provided above to calculate the predicted value. However, certain differences may also exist. For example, step S110 may include: determining push information features for calculating the predicted value; and determining user features for calculating the predicted value.

The push information features may include various information such as a release position of the push information, a release time, duration of the push information, an information volume of the push information, and an identifier of the push information.

The user features are used for calculating the predicted value, and the user features may include various features such as user age, gender, skin color, nationality, and profession, etc. The value of the number I may be a sum of the number of push information features and the number of the user features.

When the push information is pre-selected, if the push information is pre-selected merely according to the push information features, it may lead to omitting the impact of feature characteristics on the push effects of the push information, causing the push information with good push effects to have a low predicted value. By introducing the user features, the user features can be used as features for calculating the predicted value. With reference to technical solutions provided in previous embodiments, xᵢ may be a value of the push information feature or user feature, so as to further improve the pre-selection accuracy of the push information.

Further, in one embodiment, by determining the user features, a small number of user features of the users, rather than all user features, are selected as user features for calculating the predicted value. In this way, a large calculation amount due to excessively large number of user features can be avoided. For example, it is determined that a specified number of user features are used in calculating the predicted value. The specified number is a predetermined value and, usually, the specified quantity is an integer not less than 1, for example, 2 or more than 2.

The push information features may be selected using any appropriate ways, and two ways are described below as examples.

First, in step S110, determining user features for calculating the predicted value may include: determining reliability of the user features; and selecting the user features for calculating the predicted value based on the reliability.

In one embodiment, the reliability may be a probability of truthfulness or correctness of the user features. Reliability of the user features can be assigned a value according to the manner in which the user features are obtained. For example, the obtaining manner may include features determined based on user input and features obtained by automatically performing information processing and integration by the electronic device. For example, a user may fill in gender, age, school graduated, and the like in a social network. Features integrated by the electronic device include features such as user behavior preference determined based on user operations.

When the reliability is determined, the reliability may also be determined according to feature attributes of the user features. For example, the electronic device collects statistics on frequency information that the user logs in and pays attention to a topic and frequency information that is filled by the user, and the user feature attributes and information sources may be combined. In this case, when the reliability is determined, because the statistics of frequency information of the electronic device is often more accurate than the frequency information filled in by the user, when a value is assigned to the reliability, a higher value is assigned if the electronic device collects statistics on the frequency information, and a lower value is assigned if the frequency information is filled in by the user.

For another example, for the user gender, the electronic device may analyze and decide, by using user behavior characteristics, whether the user is a female user or a male user. However, obviously, in a relatively transparent social application or an acquaintance social event, a user gender filled in by the user or a friend is more accurate than that analyzed by the electronic device according to the user behavior characteristics. In this case, a value is assigned to the reliability by combining the feature attributes and the information sources. In specific implementation, other ways for determining the reliability of the user features may also be used.

After the reliability is determined, user features for calculating the predicted value are selected according to the reliability. According to an ascending order of reliability, the N user features corresponding to reliability values ranked from the top are selected as the user features for calculating the predicted value. For another example, user features whose reliability values are greater than a reliability threshold are selected as the user features of the predicted value.

Second, in step S110, determining user features for calculating the predicted value may include: selecting one or more unprocessed user features from the user features as the user features for calculating the predicted value.

In one embodiment, the user features are divided into processed features and unprocessed features. The processed features are features obtained based on processing of multiple information items, and the unprocessed features may include features that are filled in by the user and that are not determined in a manner such as secondary information integration. For example, the age, name, identity card number, and original domicile address that are obtained by scanning an identity card are all the unprocessed features.

For another example, according to a recorded statistical frequency of opening an application A by the user, a feature obtained by using a direct statistical operation and not by secondary integration processing with other information may also be an unprocessed feature. The processed feature may include all features except determined unprocessed features. For example, a user feature of consumption level of a user can be determined according to ways in which the user purchases goods, services, traveling tickets, etc., integrating the user purchasing behavior and booking behavior, and thus is the processed feature.

Because the unprocessed feature is not processed, that is, with determined directness, the unprocessed feature has accuracy higher than the processed feature. Therefore, in one embodiment, one or more unprocessed features are used as the user features for calculating the predicted values. The number of the user features for calculating the predicted value may be a static preset number or may be a dynamic number that is dynamically determined. For example, if all unprocessed features are used as the user features for calculating the predicted value, the number of the user features for calculating the predicted value is dynamically determined. Certainly, a preset number may be predetermined in advance, so that the preset number of unprocessed features are selected from multiple unprocessed features as the user features for calculating the predicted value. As to how to select several unprocessed features as the user features for calculating the predicted value, for example, priorities may be set to the unprocessed features in advance, and several user features for calculating the predicted value are selected according to the priorities.

In one embodiment, basic user features of the user may be selected as the user features for calculating the predicted value. For example, relatively basic information of the user such as age, gender, profession, area located, and education background can be selected as the user features for calculating the predicted value. Certainly, these basic information items may be filled in by the user or a friend of the user, and may be used as user features with relatively high reliability. Such unprocessed features with relatively high accuracy may be selected as the user features for calculating the predicted value.

In one embodiment, the user features are first introduced into the pre-selection of the push information, so that the issue of low accuracy resulting from that only push information features are used to pre-select the push information is resolved. In addition, by means of selecting the user features, only some user features are selected for calculation, so as to reduce the information amount and avoid decrease in pre-selection efficiency. Finally, when the user features are selected, the user features may be selected according to the reliability, or unprocessed features may be selected to participate in calculation. Thus, no matter which way is used to select the user features, the accuracy of calculation can be improved again.

As shown in FIG. 3, the present disclosure also provides a push information pre-selecting apparatus, and the apparatus includes a determination unit 110, a calculation unit 120, and a selection unit 130, etc.

The determination unit 110 is configured to determine a feature for calculating a predicted value, and a weight corresponding to the feature according to historical push data of the push information. The calculation unit 120 is configured to calculate a standard deviation of the feature.

The determination unit 130 is further configured to determine a fluctuation probability of the standard deviation. The calculation unit 120 is further configured to calculate the predicted value based on the weight, the standard deviation, and the fluctuation probability, the standard deviation and the fluctuation probability being used for calculating a fluctuation value correcting the weight. The selection unit 130 is configured to select, based on the predicted value, push information satisfying a preset condition.

Specific structures of the determination unit 110 and the selection unit 130 may correspond to a processor or a processing circuit. The processor may include a processing structure such as an application processor, a central processing unit, a microprocessor, a digital signal processor, or a programmable array. The processing circuit may include a dedicated integrated circuit.

The determination unit 110 and selection unit 130 may separately correspond to different processors or processing circuits or may be integrated to correspond to a same processor or processing circuit. When the determination unit 110 and the selection unit 130 are integrated to correspond to a same processor or processing circuit, the processor or processing circuit may separately implement functions of the determination unit 110 and the selection unit 130 by means of time division multiplexing or thread concurrency.

A specific structure of the calculation unit 120, in one embodiment, may correspond to a structure of a calculator or a processor having a calculation function. The calculation unit 120 is first used for calculating the standard deviation, then calculating the fluctuation value by using the standard deviation and the fluctuation probability, calculating the corrected weight by using the fluctuation value and the weight, and finally calculating the predicted value based on the corrected weight and the value of the feature.

As shown in FIG. 4, the present disclosure provides a push information pre-selecting apparatus, including a processor 220, a storage medium 240, a display 250, and at least one external communications interface 210. The processor 220, the storage medium 240, and the external communications interface 210 are all connected by using a bus 230. The processor 220 may be an electronic part and component with a processing function such as a microprocessor, a central processing unit, a digital signal processor, or a programmable logic array. Computer executable instructions are stored on the storage medium 240. The processor 220 executes the computer executable instructions stored in the storage medium 240 to perform any one of the foregoing methods, specifically, for example, determining a feature for calculating a predicted value, and a weight corresponding to the feature according to historical push data of the push information; calculating a standard deviation of the feature; determining a fluctuation probability of the standard deviation; calculating the predicted value based on the weight, the standard deviation, and the fluctuation probability, the standard deviation and the fluctuation probability being used for calculating a fluctuation value correcting the weight; and selecting, based on the predicted value, push information satisfying a preset condition.

In one embodiment, refer to corresponding embodiments for relevant descriptions of the standard deviation, the fluctuation probability, and the predicted value. Details are not repeated herein. The fluctuation probability may be a random probability. For example, the fluctuation probability is equal to a Gaussian random probability value.

The push information pre-selecting apparatus, in one embodiment may be a structure composed of one or more servers for pre-selecting push information. The server may be a device located in a platform of push information such as advertisements. Thus, the push information pre-selecting apparatus provides implementation hardware to the disclosed push information pre-selecting methods and has high pre-selection accuracy of the push information.

In an embodiment, the determination unit 110 is further configured to determine a fluctuation coefficient, where the fluctuation coefficient is used for limiting a value range of the fluctuation value. The calculation unit 120 is configured to calculate the predicted value based on the weight, the standard deviation, the fluctuation probability, and the fluctuation coefficient.

In one embodiment, the determination unit 110 may correspond to a human-machine interaction interface, and the fluctuation coefficient entered by a working staff may be received by using the human-machine interaction interface. Certainly, the determination unit 110 may also correspond to a processor or a processing circuit and read the fluctuation coefficient prestored in a computer storage medium, or may correspond to a communications interface, so that other electronic devices find or receive the fluctuation coefficient.

In one embodiment, the calculation unit 120 specifically calculates the predicted value according to the weight, the standard deviation, the fluctuation probability, and the fluctuation coefficient. The fluctuation coefficient, the standard deviation, or the fluctuation probability is a parameter for calculating a fluctuation value. The specific calculation function relationship or method can refer to previous descriptions.

Accordingly, by introducing the fluctuation coefficient to this embodiment, a situation in which the predicted value is abnormal due to an excessively large standard deviation is alleviated, so as to improve the accuracy of calculation.

In another embodiment, the determination unit 110 is further configured to determine a fluctuation coefficient, where the fluctuation coefficient is used for limiting a value range of the fluctuation value. the calculation unit 120 is configured to calculate the predicted value based on the weight, the standard deviation, the fluctuation probability, and the fluctuation coefficient.

In an embodiment, the determination unit 110 is configured to determine a safety factor, where the safety factor is used for preventing abnormal solution of the fluctuation value caused when the standard deviation is a particular value or the standard deviation is not obtained. The calculation unit 120 is configured to calculate the predicted value based on the weight, the standard deviation, the fluctuation probability, and the safety factor.

The safety factor is also introduced into the calculation. The safety factor may be an extremely small value such as a constant less than one thousandth. In one embodiment, refer to the determined hardware structure of the fluctuation coefficient in previous embodiments for a hardware structure corresponding to the determination unit 110. However, a difference lies in the safety factor to be determined. The standard deviation abnormity may include that the standard deviation is a predetermined abnormal value, or that the standard deviation value is not obtained, or other standard deviation obtaining status satisfying an abnormity condition.

Further, the safety factor in the embodiments of this embodiment, same as the fluctuation coefficient, the standard deviation, and the fluctuation probability, is a dependent variable participating in calculation of the fluctuation value.

In one embodiment, calculation unit 120 calculates the fluctuation value based on the safety factor, avoiding the issue that a fluctuation value abnormity causes a predicted value abnormity and reducing occurrence of an abnormal situation in the calculation process.

There are multiple function relationships for calculating the predicted value. In one embodiment, the calculation unit 120 is used for calculating the predicted value y by using the following formula:

$$y = \frac{1}{1 + {e}^{- \sum ( {w}_{i} + α \sqrt{\frac{1}{β + \frac{1}{{σ}_{i}^{2}}} * p} ) {x}_{i}}}$$

where xᵢ is a value of a feature i, wᵢ is a weight of the feature i, α is the fluctuation coefficient, β is the safety factor, and σᵢ is a standard deviation of the feature.

Certainly, the calculation unit may calculate the predicted value by using a Bayesian algorithm or a logistic regression algorithm. Other algorithms may also be used.

Thus, the present disclosure provides an apparatus of specifically calculating the predicted value. The apparatus has a characteristic of high accuracy of pre-selecting push information according to the predicted value and also has characteristics of a simple structure and being convenient to implement.

In some embodiments, the determination unit 110 is configured to: determine push information features for calculating the predicted value; and determine user features for calculating the predicted value.

A hardware structure of the determination unit 110 is similar to that of the determination unit provided in the foregoing embodiments. It should be noted that the features determined by the determination unit 110 that are used for calculating the predicted value include push information features and user features. The push information features may include various push information parameters, such as push position and push time, and the user features may include various forms of features of the user.

In this way, the push information pre-selecting apparatus pays attention to the push information features as well as the user features when calculating the predicted value and does not separate the user features and the push information features. Thus, when the predicted value is calculated, it can avoid the situation where the impact of the user features on push effects is omitted, so as to improve the pre-selection accuracy of push information again.

There are multiple optional structures corresponding to the determination unit 110. For example, two optional structures are described below.

First, the determination unit 110 may be configured to: determine reliability of the user features; and select the user features for calculating the predicted value based on the reliability. In this case, the determination unit 110 may also correspond to a processor or a processing circuit or may correspond to a comparator. For example, by means of comparison by the comparator, user features whose reliabilities are greater than a reliability threshold are selected as the user features for calculating the predicted value.

Second, the determination unit 110 may be specifically configured to select one or more unprocessed user features from all the user features as the user features for calculating the predicted value. In one embodiment, a hardware structure corresponding to the determination unit 110 may also include a processor or a processing circuit. By dividing the user features into unprocessed features and processed features, one or more unprocessed features are selected as the user features for calculating the predicted value.

Thus, in the push information pre-selecting apparatus of this embodiment, the user features are first introduced to calculate the predicted value, and a result of pre-selecting push information based on the predicted value has a characteristic of high accuracy. Then, a problem of a large calculation amount caused by introducing user features to calculation may be avoided by filtering the user features. Further, user features with high reliabilities or user features that can accurately represent user characteristics such as unprocessed features are selected to participate in calculation, thereby improving accuracy of the pre-selection result again.

For example, the push information may be advertisements, and a method for pre-selecting advertisements based on any technical solution described in the previous embodiments is explained. In one embodiment, a predicted value Y of advertisement is calculated by using the following formula, and the predicted value may be a probability for the advertisement to be clicked.

$$y = \frac{1}{1 + {e}^{- \sum ( {w}_{i} + α \sqrt{\frac{1}{β + \frac{1}{{σ}_{i}^{2}}} * rand\_gaussian} ) {x}_{i}}}$$

where xᵢ is a value of a feature i, wᵢ is a weight of the feature i, α is the fluctuation coefficient, β is the safety factor, and σᵢ is a standard deviation of the feature. rand_gaussian is a random probability determined by obeying Gaussian random distribution.

α is a fluctuation coefficient of a fluctuation value. When α is 0, the fluctuation value does not act.

β is an extremely small constant and may be usually one ten-thousandth.

σᵢ is a standard deviation of to-be-processed data whose feature i has a value of a specified value. Solution of the standard deviation is described by using the following table as an example. In this example, a classification model may be first determined according to historical advertisement data, and then advertisement information of a to-be-placed advertisement in a database and to-be-tested user data are processed by using the classification model, to determine a probability for the user to click the advertisement. The advertisement information is the to-be-tested user data, that is, the to-be-processed data.

TABLE 1

| Row | | Whether | | | | |
|---|---|---|---|---|---|---|
| sequence | Whether | being | Whether | Whether | Whether | Category |
| number | being male | female | being order 1 | being order 2 | being order 4 | tag |
| 1 | 1 | 0 | 1 | 0 | 0 | 1 |
| 2 | 0 | 1 | 1 | 0 | 0 | 0 |
| 3 | 0 | 1 | 1 | 0 | 0 | 0 |
| 4 | 1 | 0 | 1 | 0 | 0 | 0 |
| 5 | 1 | 0 | 1 | 0 | 0 | 0 |
| 6 | 1 | 0 | 0 | 1 | 0 | 0 |

In Table 1 above, 5 middle columns are referred to as feature columns, the first column is a row sequence number column, and the seventh column is a category tag column. The i is a sequence number of the feature column. “1” in the feature column in Table 1 represents that a logic value is “yes”, and “0” represents that a logic value is “no”. For example, in a second column, “1” represents being male, and “0” represents being not male.

For the second column, there are four records of male, and the four records are respectively in feature rows whose row sequence numbers are 1, 4, 5, and 6, and category tags corresponding to the four rows are respectively 1, 0, 0, and 0. Therefore, calculation of σᵢ is calculation of a standard deviation of (1, 0, 0, 0). Certainly, there are more than one specific manner for solving the standard deviation, and one specific example is provided herein.

Predicted values of small- and medium-sized advertisements have some fluctuation by introducing the fluctuation value, so that these orders have an opportunity of participating in contest, so as to ensure ecological health of an entire advertisement system and prevent individual orders from occupying most exposure.

In addition, by using the foregoing formula to calculate the predicted value, the user features can be directly introduced into the pre-selection process, such as basic information of the user including age and gender, which can be used, together with order information such as advertisement position and order ID, as the features. The order information is substantially a constituent part of the push information features mentioned in the previous embodiments.

FIG. 5 is a diagram of calculating the predicted value and shows training with training data. The training data corresponds to the historical push data. In one embodiment, 01 is used to discretize the user features and advertisement features. For example, two sequences, 0100 and 1000, in FIG. 5 correspond to different ages or different age groups of the user. 10 and 01 correspond to different advertisements. Age*advertisement represents a Cartesian product of a feature column corresponding to ages and a feature column corresponding to advertisements. X*x shown in FIG. 5 represents other un-shown user features or advertisement features. When a predicted value of an advertisement is calculated, only an advertisement column usually appears, and 0 and 1 are used to respectively represent whether corresponding users watches or clicks the advertisement.

The category tags in the training data are used for representing whether a user in the historical advertisement data executes a conversion operation such as clicking on the advertisement. For example, the training data includes a record that a user A clicks an advertisement B. Therefore, in FIG. 5, in a training data row in which the user A is located, an age of the user A and advertisements watched by the user A are recorded, and the corresponding category tag in the training data row in which the user A is located uses “1” to represent that the user A watches the advertisement.

The training data is trained to obtain a training model based on w and σ. w represents a weight, and σ represents a standard deviation. A predicted value Y is calculated. 0.02 in the figure represents that the predicted value y calculated in an example is 0.02. A value of a category tag in a data row corresponding to the predicted value represents the predicted value, and the predicted value is a probability for the advertisement that a training model obtained based on the historical advertisement determines to push to the clicked.

An embodiment of the present invention further provides a computer storage medium, the computer storage medium storing computer executable instructions, and the computer executable instructions being used for performing at least one of the methods for pre-selecting push information of the previous embodiments, for example, performing the method shown in FIG. 1 and/or FIG. 2.

The computer storage medium may be a random storage medium RAM, a read-only storage medium ROM, a flash memory Flash, a magnetic tape, or an optical disk, and optionally, may be a non-transient storage medium.

In several embodiments provided in this application, it should be understood that the disclosed device and method can be implemented in other manners. The above-described device embodiments are merely schematic. For example, division of the units is merely division of logic functions and may be another division manner during actual implementation. For example, multiple units or components may be combined or may be integrated into another system, or some features may be omitted or not be executed. In addition, mutual coupling, direct coupling, or communication connection between the displayed or discussed constituent parts may be indirect coupling or communication connection by means of some interfaces, devices, or units and may be electric, mechanical, or of another form.

The foregoing units described as separate components may be or may not be physically separated. Components displayed as units may be or may not be physical units, and may be located in one place or may be distributed on multiple network units. An objective of the solutions of this embodiment may be implemented by selecting some or all of the units according to actual needs.

In addition, the functional modules in the embodiments of the present invention may be integrated into one processing unit, or each of the units may be used as a unit alone, or two or more units may be integrated into one unit. The integrated units may be implemented in the form of hardware, or may be implemented in the form of a hardware and software functional unit.

A person of ordinary skill in the art may understand that all or some of the steps of the foregoing method embodiments may be implemented by using hardware relevant to a program instruction. The program may be stored in a computer readable storage medium. When being executed, the program executes steps of the foregoing method embodiments. The storage medium includes: various media capable of storing program code such as a mobile storage device, a read-only memory (ROM, Read-Only Memory), a random access memory (RAM, Random Access Memory), a magnetic disk, or an optical disc.

The foregoing descriptions are merely specific implementations of the present invention, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure should be subject to the protection scope of the claims.

What is claimed is:

1. A push information pre-selecting method, comprising:
based on historical push data of push information including a plurality of push information items, determining, by a computing terminal including at least one processor, a feature for calculating a predicted value, and a weight corresponding to the feature;
calculating, by the computing terminal, a standard deviation of the feature;
determining, by the computing terminal, a fluctuation probability of the standard deviation;
calculating, by the computing terminal, the predicted value based on the weight, the standard deviation, and the fluctuation probability, the standard deviation and the fluctuation probability being used for calculating a fluctuation value for correcting the weight;
based on the predicted value, selecting, by the computing terminal, push information items satisfying a preset condition; and
pushing, by the computing terminal, the selected push information items to a target user.

2. The method according to claim 1, further comprising:
determining a fluctuation coefficient, wherein the fluctuation coefficient is used for limiting a value range of the fluctuation value,
wherein the calculating the predicted value based on the weight, the standard deviation, and the fluctuation probability comprises:
calculating the predicted value based on the weight, the standard deviation, the fluctuation probability, and the fluctuation coefficient.

3. The method according to claim 2, further comprising:
determining a safety factor, wherein the safety factor is used for preventing an abnormal fluctuation value caused when the standard deviation is of a particular value or the standard deviation is not obtained,
wherein the calculating the predicted value based on the weight, the standard deviation, and the fluctuation probability comprises:
calculating the predicted value based on the weight, the standard deviation, the fluctuation probability, and the safety factor.

4. The method according to claim 3, wherein the calculating the predicted value based on the weight, the standard deviation, the fluctuation probability, and the safety factor comprises:
calculating the predicted value Y by:
$$y = \frac{1}{1 + {e}^{- \sum ( {w}_{i} + α \sqrt{\frac{1}{β + \frac{1}{{σ}_{i}^{2}}} * p} ) {x}_{i}}}$$
wherein xᵢ is a value of a feature i, wᵢ is a weight of the feature i, α is the fluctuation coefficient, β is the safety factor, and σᵢ is a standard deviation of the feature.

5. The method according to claim 1, wherein the determining a feature for calculating a predicted value, and a weight corresponding to the feature comprises:
determining push information features for calculating the predicted value; and
determining user features for calculating the predicted value.

6. The method according to claim 5, wherein the determining user features for calculating the predicted value comprises:
determining reliability of the user features; and
selecting certain user features from the user features for calculating the predicted value based on the reliability of the user features.

7. The method according to claim 5, wherein the determining user features for calculating the predicted value comprises:
selecting one or more unprocessed user features from the user features as the certain user features for calculating the predicted value.

8. A push information pre-selecting apparatus, comprising:
a memory storing instructions; and
a processor coupled to the memory and, when executing the instructions, configured for:
based on historical push data of push information including a plurality of push information items, determining a feature for calculating a predicted value, and a weight corresponding to the feature;
calculating a standard deviation of the feature;
determining a fluctuation probability of the standard deviation;
calculating the predicted value based on the weight, the standard deviation, and the fluctuation probability, the standard deviation and the fluctuation probability being used for calculating a fluctuation value for correcting the weight;
based on the predicted value, selecting push information items satisfying a preset condition; and
pushing the selected push information items to a target user.

9. The apparatus according to claim 8, wherein the processor is further configured for:
determining a fluctuation coefficient, wherein the fluctuation coefficient is used for limiting a value range of the fluctuation value,
wherein the calculating the predicted value based on the weight, the standard deviation, and the fluctuation probability comprises:
calculating the predicted value based on the weight, the standard deviation, the fluctuation probability, and the fluctuation coefficient.

10. The apparatus according to claim 9, wherein the processor is further configured for:
determining a safety factor, wherein the safety factor is used for preventing an abnormal fluctuation value caused when the standard deviation is of a particular value or the standard deviation is not obtained,
wherein the calculating the predicted value based on the weight, the standard deviation, and the fluctuation probability comprises:
calculating the predicted value based on the weight, the standard deviation, the fluctuation probability, and the safety factor.

11. The apparatus according to claim 10, wherein the processor is further configured for:
calculating the predicted value y by:
$$y = \frac{1}{1 + {e}^{- \sum ( {w}_{i} + α \sqrt{\frac{1}{β + \frac{1}{{σ}_{i}^{2}}} * p} ) {x}_{i}}}$$
wherein xᵢ is a value of a feature i, wᵢ is a weight of the feature i, α is the fluctuation coefficient, β is the safety factor, and σᵢ is a standard deviation of the feature.

12. The apparatus according to claim 8, wherein the processor is further configured for:
determining push information features for calculating the predicted value; and
determining user features for calculating the predicted value.

13. The apparatus according to claim 12, wherein the processor is further configured for:
determining reliability of the user features; and
selecting certain user features from the user features for calculating the predicted value based on the reliability of the user features.

14. The apparatus according to claim 12, wherein the processor is further configured for:
selecting one or more unprocessed user features from the user features as the certain user features for calculating the predicted value.

15. A non-transitory computer-readable storage medium containing computer-executable instructions for, when executed by one or more processors, performing a push information pre-selecting method, the method comprising:
based on historical push data of push information including a plurality of push information items, determining a feature for calculating a predicted value, and a weight corresponding to the feature;
calculating a standard deviation of the feature;
determining a fluctuation probability of the standard deviation;
calculating the predicted value based on the weight, the standard deviation, and the fluctuation probability, the standard deviation and the fluctuation probability being used for calculating a fluctuation value for correcting the weight;
based on the predicted value, selecting push information items satisfying a preset condition; and
pushing the selected push information items to a target user.

16. The non-transitory computer-readable storage medium according to claim 15, the method further comprising:
determining a fluctuation coefficient, wherein the fluctuation coefficient is used for limiting a value range of the fluctuation value,
wherein the calculating the predicted value based on the weight, the standard deviation, and the fluctuation probability comprises:
calculating the predicted value based on the weight, the standard deviation, the fluctuation probability, and the fluctuation coefficient.

17. The non-transitory computer-readable storage medium according to claim 16, the method further comprising:
determining a safety factor, wherein the safety factor is used for preventing an abnormal fluctuation value caused when the standard deviation is of a particular value or the standard deviation is not obtained,
wherein the calculating the predicted value based on the weight, the standard deviation, and the fluctuation probability comprises:
calculating the predicted value based on the weight, the standard deviation, the fluctuation probability, and the safety factor.

18. The non-transitory computer-readable storage medium according to claim 17, wherein the calculating the predicted value based on the weight, the standard deviation, the fluctuation probability, and the safety factor comprises:
calculating the predicted value y by:
$$y = \frac{1}{1 + {e}^{- \sum ( {w}_{i} + α \sqrt{\frac{1}{β + \frac{1}{{σ}_{i}^{2}}} * p} ) {x}_{i}}}$$
wherein xᵢ is a value of a feature i, wᵢ is a weight of the feature i, α is the fluctuation coefficient, β is the safety factor, and σᵢ is a standard deviation of the feature.

19. The non-transitory computer-readable storage medium according to claim 15, wherein the determining a feature for calculating a predicted value, and a weight corresponding to the feature comprises:
determining push information features for calculating the predicted value; and
determining user features for calculating the predicted value.

20. The non-transitory computer-readable storage medium according to claim 19, wherein the determining user features for calculating the predicted value comprises:
determining reliability of the user features; and
selecting certain user features from the user features for calculating the predicted value based on the reliability of the user features.
